(19) United States
(12) Patent Application Publication
(10) Pub. No.: US 2026/0114477 A1
(43) Pub. Date: Apr. 30, 2026

(54) REFORMATTED INSECT FOOD PRODUCT FOR AQUATIC ENVIRONMENTS

(71) Applicant: Google LLC, Mountain View, CA (US)

(72) Inventors: Tiantian Zha, South San Francisco, CA (US); Charles Behling, Brisbane, CA (US); Martin Lozano, Berkeley, CA (US); Peter Massaro, San Carlos, CA (US)

(73) Assignee: Google LLC, Mountain View, CA (US)

(21) Appl. No.: 19/431,572

(22) Filed: Dec. 23, 2025

Related U.S. Application Data
(62) Division of application No. 16/401,350, filed on May 2, 2019.

(51) Int. Cl. A23K 50/80; A01K 61/85; A23K 40/30; A23P 10/28

(52) U.S. Cl. CPC A23K 50/80; A01K 61/85; A23K 40/30; A23P 10/28

(57) ABSTRACT

A reformatted insect food product comprising a mixture of at least one nutrient source suitable for an aquatic organism. The reformatted insect food product includes a first dissolvable capsule casing and a second dissolvable capsule casing. The first dissolvable capsule casing contains a first measured amount of the at least one nutrient source within and is sealed to form a first sealed dissolvable capsule. The second dissolvable capsule casing contains a second measured amount of the at least one nutrient source and the first sealed dissolvable capsule and is sealed to form a second sealed dissolvable capsule.

### CROSS REFERENCE TO RELATED APPLICATIONS

This application is a divisional application of U.S. patent application Ser. No. 16/401,350, filed May 2, 2019, titled “REFORMATTED INSECT FOOD PRODUCT FOR AQUATIC ENVIRONMENTS,” the entirety of which is hereby incorporated by reference.

### FIELD

The present disclosure relates generally to the mass-rearing of insects. More specifically, but not by way of limitation, this disclosure relates to various formats of insect food and methods of manufacturing the various formats of insect food for aquatic environments.

### BACKGROUND

Insects or developmental stages of insects that inhabit aquatic environments, such as larvae and pupae, need to be periodically fed a relatively precise amount of food. Typically, the food is stored in a dry powder form and, for each feeding, is manually measured and dispensed by weight, which can be tedious and time consuming. This results in a slow and potentially inaccurate process of feeding the insect larvae and pupae and only allows for the feeding to occur while a person is present to perform the feeding. Additionally, the dry powder form of food may stay floating at the surface of the liquid that the larvae or pupae are inhabiting. The larvae or pupae are often unable or unwilling to swim to the surface to feed. The dry powder form of food may also disperse unevenly throughout the liquid leading to an uneven distribution of food amongst the insect larvae and pupae, which could negatively impact the yield of the insect larvae and pupae.

The food may also be fed to the insect larvae and pupae in the form of a slurry, where the dry powder form of food is mixed with a liquid. However, these slurries have a limited shelf life after being made and typically require time-consuming cleaning of any surface the slurry passes over to prevent build-up and bacteria growth. In addition, both powders and slurries tend to foul the aquatic environment over time, potentially harming part of the insect population.

### SUMMARY

Various examples are described for a reformatted insect food product for aquatic environments and methods for manufacturing and using that reformatted insect food product. One example product includes a measured amount of a mixture of at least one nutrient source suitable for an aquatic organism formed into a dispensable unit.

One example method includes creating a mixture comprising at least one nutrient source suitable for an aquatic organism; separating out a measured amount of the mixture; and forming a dispensable food unit using the measured amount of the mixture.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1A and 1B show an example for a reformatted insect food product for aquatic environments according to this disclosure;

FIG. 2 shows an example aquatic environment according to this disclosure;

FIGS. 3A-9 show other examples for a reformatted insect food product for aquatic environments according to this disclosure;

FIG. 10 shows a flowchart for an example method for manufacturing a reformatted insect food product for aquatic environments according to this disclosure;

FIG. 11 shows a flowchart for an example method for feeding a plurality of insect larvae or pupae a reformatted insect food product for aquatic environments according to this disclosure; and

FIG. 12 shows an example computing device for use with feeding a plurality of insect larvae or pupae a reformatted insect food product for aquatic environments or with manufacturing a reformatted insect food product for aquatic environments according to this disclosure.

### DETAILED DESCRIPTION

Examples are described herein in the context of reformatted insect food products for aquatic environments and methods for manufacturing and using that reformatted insect food product. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Mass rearing insects in a controlled environment involves providing a suitable living environment for the insects during their development cycle as well as providing sufficient food and water to enable them to grow and thrive. In particular, raising juvenile insects can require feeding specific amounts of food to insect larvae or pupae at frequent intervals. Standard dry powder food makes this difficult to accomplish because each dose for each feeding must be measured by hand. Human error often causes the amount of dry powder food to be inaccurately measured and controlled, particularly when performing individual measurements for a large number of insect rearing environments, e.g., for dozens or hundreds of insect rearing trays. Examples according to this disclosure can provide for a way to quickly and accurately dispense food for the insect larvae or pupae by using a reformatted insect food product for aquatic environments.

In an illustrative example, two types of powder are mixed in a 50/50 ratio by weight and then formed into a tablet using a binding agent (or agents). In this example, the mixture is 50% by weight cricket protein powder and 50% by weight bovine liver powder. The mixture of these two different proteins helps reduce the build-up of potentially toxic material in the aquatic environment. In particular, the cricket protein powder helps to keep the chemistry of the liquid that the insect larvae or pupae are inhabiting balanced: too much bovine liver powder can turn into ammonia when it is dispersed in the liquid. To create the tablet, a binding substance, such as a sugar, is added to the mixture to help the tablet maintain its shape. Then 200 mg of the protein powder and sugar mixture is measured and molded to form the small, cylindrical tablet.

These tablets feature numerous advantages over the dry powder food currently being used. For example, the tablets can be easily produced to contain a precise amount of the food mixture, which eliminates the need for manual measurement of each food dosage. In addition, simply selecting one or more tablets per insect population is less time consuming if performed manually, and further may enable automated feeding. It can also enable accurate logging and reporting of the amount of food the populations of insect larvae or pupae are being fed. In addition, the tablets are clean and easy to distribute throughout the liquid that the insect larvae or pupae are inhabiting.

In this example, the tablets are distributed to the insect larvae or pupae using an automated blow feeder. Because the tablets are dry and only dissolve in a liquid, they are easily handled and distributed by the automated blow feeder. The blow feeder also has sensors, such as an optical sensor, that are able to detect each tablet distributed by the blow feeder. The automated blow feeder allows for a regular feeding schedule to be maintained even when a human is not physically present to distribute the tablets.

This illustrative example is given to introduce the reader to the general subject matter discussed herein and the disclosure is not limited to this example. The following sections describe various additional non-limiting examples and examples of a reformatted insect food product for aquatic environments and methods for manufacturing and using that reformatted insect food product.

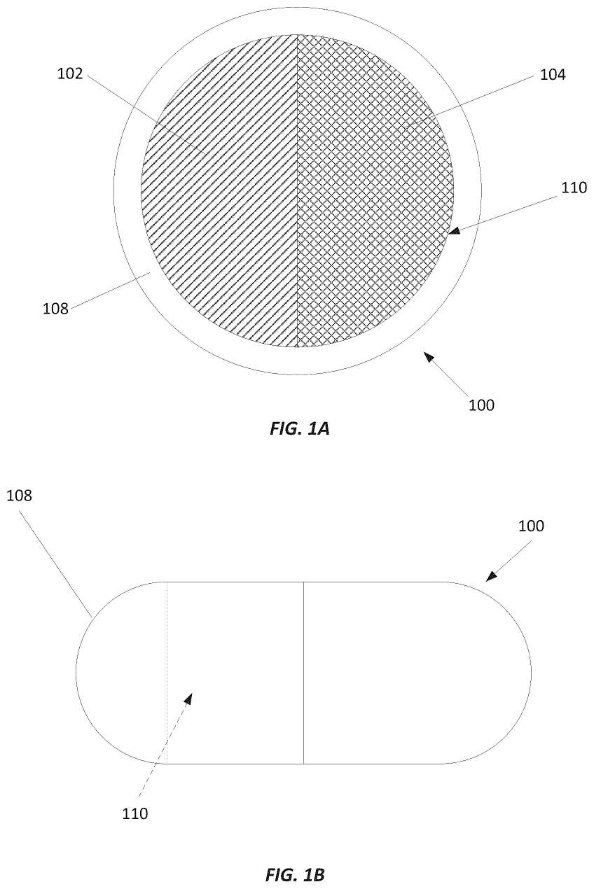

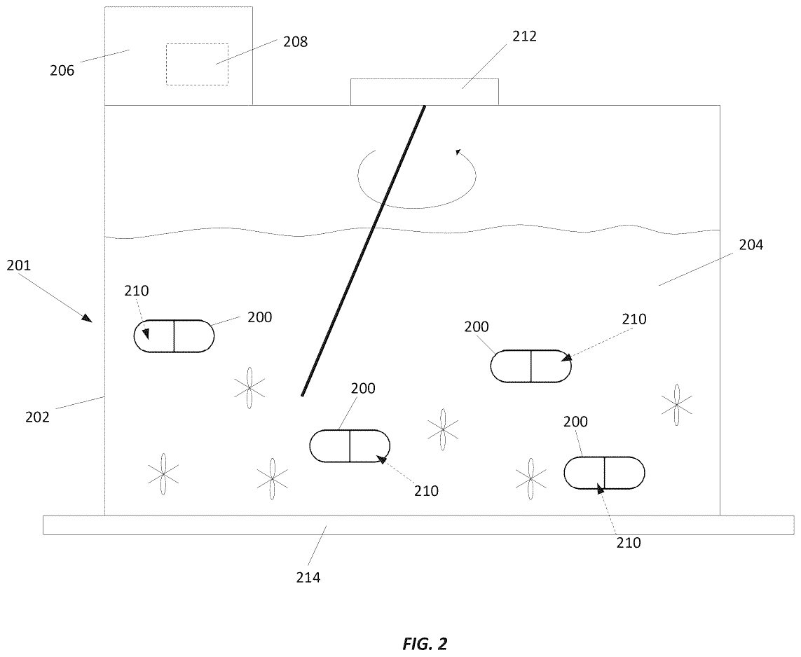

Referring now to FIGS. 1A and 1B, FIGS. 1A and 1B show an example of a reformatted insect food product 100 for aquatic environments. The reformatted insect food product 100 is made from a mixture 110 of powdered food. In this example, the mixture 110 includes cricket protein powder 102 and bovine liver powder 104. However, in other examples, the mixture 110 may contain any suitable nutrient source for an aquatic organism or aquatic life-stage of an insect, e.g., Tetramin®. The proportion of cricket protein powder 102 to bovine liver powder 104 may be varied such that the mixture 110 is made from at least 1% by weight cricket protein powder 102. For example, the reformatted insect food product 100 may be made from a mixture 110 of substantially 50% by weight cricket protein powder 102 and substantially 50% by weight bovine liver powder 104. In another example, the reformatted insect food product 100 may be formed from substantially 100% cricket protein powder 102. Using a reformatted insect food product 100 formed from substantially 100% cricket protein powder 102 helps to maintain a balanced chemistry of the aquatic environment in which the insect larvae and pupae are inhabiting. It should be appreciated that, while shown as separated in FIG. 1A, the two protein powders 102, 104 are in fact mixed together into a single undivided mixture 110.

FIGS. 1A and 1B show a measured amount of the mixture 110 formed into the food product 100, such as a pill. For example, the measured amount of the mixture 110 may be 200 mg, 500 mg, 1 g, or any other suitable amount depending on the number of larvae or pupae that are to be fed. By forming food products 100 that are dispensable units of measured amounts of the mixture 110, the food products 100 may dose consistent, precise, and known amounts of food for the insect larvae and pupae. This will save time and improve accuracy during the feeding process because a person will not have to manually measure each dose of food for each feeding. The measured amount of the mixture 110 fed to the insect larvae or pupae is also easily quantifiable when using the food products 100, which allows for easy and accurate logging and reporting of feeding activities.

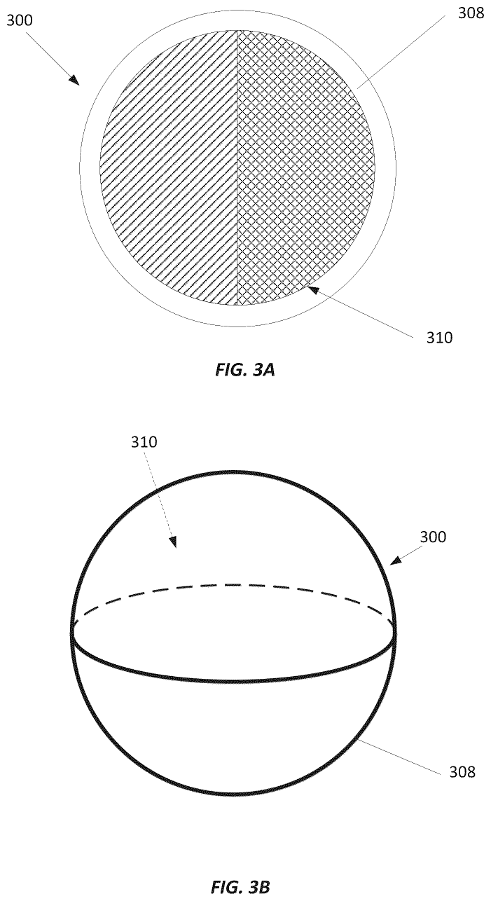

The food product 100 may take a variety of shapes and forms including a pill, a tablet, a pellet, a granule, a food sheet, or a food rope. These various forms will be discussed in more detail below in reference to FIGS. 3A-9.

The example reformatted insect food product 100 shown in FIGS. 1A and 1B is a pill. The pill includes a dissolvable capsule 108 that encases the measured amount of the mixture 110. The dissolvable capsule 108 is split into two halves or portions, though it is not necessary for the two parts of the dissolvable capsule 108 to be exactly 50% of the whole capsule. The measured amount of the mixture 110 is placed into one or both halves of the dissolvable capsule 108. The two halves of the dissolvable capsule 108 are then sealed together to form the pill. The two halves of the dissolvable capsule 108 may also be held together to form the pill by a form fit between the two halves, by a snap fit between the two halves, or by any other suitable connecting means. In some examples, the dissolvable capsule 108 may be shaped as a rounded cylinder, as is shown in FIG. 1B, a sphere, a small disc or cylinder, or any other suitable shape for containing the measured amount of the mixture 110.

In this example, the mixture 110 added to the dissolvable capsule 108 is the dry mixture 110 of powdered food. In other examples, a slurry may be formed by mixing the dry mixture 110 of powdered food with a liquid (e.g., water). The dissolvable capsule 108 may then be filled with a measured amount of the slurry to form the pill to be dispersed into the aquatic environment to feed the insect larvae or pupae. In some examples, the slurry may be frozen before being added to the pill or the pill itself may be frozen after it has been filled with the measured amount of the slurry. Freezing the slurry and/or the pill may help to extend the shelf life of the pills. In some examples, the slurry may simply be poured into a mold and frozen in a desired shape rather than being encapsulated.

The dissolvable capsule 108 is designed to be biologically inert when the pill is dispensed into the aquatic environment for the insect larvae or pupae. This means that the dissolvable capsule 108 itself will not affect the chemical balance of the liquid when it dissolves. In particular, it is important to not disrupt the aquatic environment where the larvae or pupae are reared and to not affect the health of the larvae or pupae if one or more of the larvae or pupae were to ingest any of the dissolvable capsule 108. Alternatively, the dissolvable capsule 108 may be designed to provide additional nutrients to the insect larvae or pupae. In some examples, the dissolvable capsule 108 may be made from any suitable dissolvable binding substance such as gelatin, hydroxypropylmethyl cellulose, agar, pectin, a sugar, a starch, or any other material capable of dissolving in the liquid in which the insect larvae or pupae are inhabiting while not negatively impacting the aquatic environment or the health of an insect population.

The dissolvable capsule 108 is also designed to dissolve at a predetermined rate. For example, the thickness of the dissolvable capsule 108 may be adjusted to adjust the amount of time it takes for the dissolvable capsule 108 to disintegrate and release the mixture contained inside the dissolvable capsule 108. In some examples, the pill may have a thin dissolvable capsule 108 that will dissolve after a short time period, for example after a few minutes. In other examples, the pill may have a thick dissolvable capsule 108 that will dissolve after an extended time period, for example after an hour or more. By simultaneously feeding multiple different pills with dissolvable capsules 108 that have differing dissolve times, the food mixture 110 contained inside the pills will be released at varying times. This enables the feeding of the insect larvae or pupae to be scheduled and to occur at regular intervals even when a person is not physically present to feed the insect larvae or pupae, e.g., at night.

Referring now to FIG. 2, FIG. 2 shows an example aquatic environment 201 and reformatted insect food products 200 for use in the aquatic environment 201. In this example, multiple reformatted insect food products 200 are dispensed into an insect rearing tray 202 that contains insect larvae or pupae and a liquid 204 (e.g., water).

The food products 200 contain a mixture 210 of powdered food, generally as discussed above in reference to the food product 100 shown in FIGS. 1A and 1B. The food products 200 may also be the food products discussed in further detail below in reference to FIGS. 3A-9, or a combination of the food products discussed in reference to FIGS. 1A, 1B, and 3A-9.

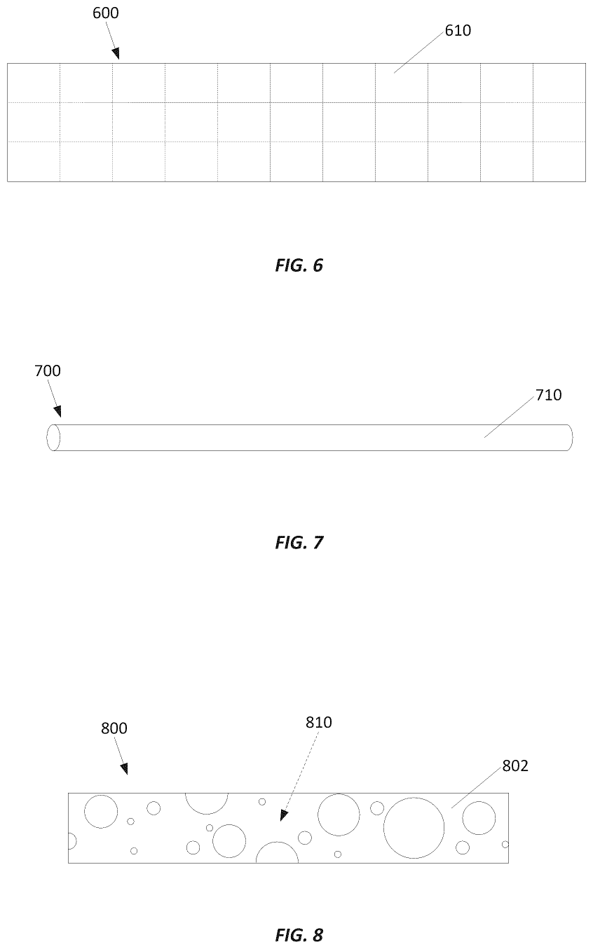

The food products 200 may be dispensed into the insect rearing tray 202 either manually or by using an automated feeder 206, and at least one sensor 208 may be used to detect and count the food products 200 as they are dispensed. The automated feeder 206 may include a passive gravity-fed drop, an auger, a broadcast spreader, a blow feeder, a conveyor belt, a drum feeder, or any other known device that may distribute the reformatted insect food product 200 into the pupaeaquatic environment 201. In some examples, the automatic feeder 206 may be designed to extrude a food sheet or a food rope, where the extruded food sheet and the extruded food rope are described below in reference to FIGS. 6 and 7. As the sheet or rope is being extruded, the automatic feeder 206 may cut off a piece of the sheet or rope so that the piece may fall into the liquid.

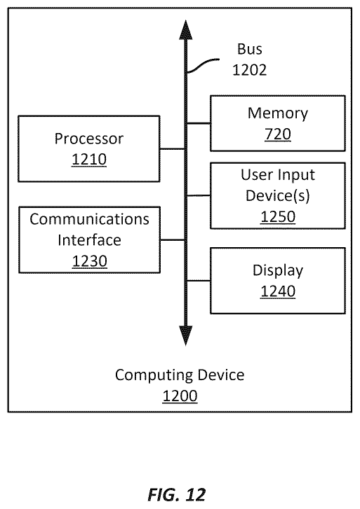

The sensor 208 may be an integral part of the automatic feeder 206, or it may be separate from the automatic feeder 206. The sensor 208 may be a touch sensor that detects the food product 200 as the food product 200 comes into contact with the touch sensor, an optical sensor that detects variations in light intensity as the food product 200 passes by the optical sensor, a vision sensor that captures images of the food product 200 as the food product 200 passes the vision sensor, or any other suitable sensor for detecting the reformatted insect food product 200. The sensor 208 may be connected to a computing device 1200, discussed in further detail below in relation to FIG. 12, in order to count and track the number of reformatted insect food products 200 that the sensor 208 detects are distributed to the aquatic environment 201, which will allow for easier tracking and reporting of the amount of food fed to the insect larvae or pupae.

Additionally, the reformatted insect food product 200 may be distributed to the plurality of insect larvae or pupae in the aquatic environment 201 automatically based on a programmed schedule. This may be done by connecting the computing device 1200, discussed in further detail below in relation to FIG. 12, to the automated feeder 206. Automating the distribution of the reformatted insect food product 200 allows the insect larvae or pupae to be fed a consistent amount of food on a reliable schedule without requiring a human to be present to manually distribute the food.

The food products 200 may partially float so that they are suspended in the liquid 204, or they may sink to the bottom of the insect rearing tray 202. The insect larvae or pupae may eat the mixture 210 as the reformatted insect food products 200 dissolve and the mixture 210 disperses. To help evenly distribute the food products 200 and the mixture 210 as it disperses, a stirring device 212 and/or a vibration generator 214 may be attached to the insect rearing tray 202 to agitate the liquid 204. The stirring device 212 may be a rod inserted into the liquid 204. The vibration generator may include vibration motors such as eccentric rotating mass (ERM) vibration motors, linear resonant actuators (LRA), an audio speaker, or any other suitable device capable of outputting a mechanical vibration. In some examples, the insect rearing tray 202 may include other mechanical motion generators to help evenly distribute the food products 200 and the mixture 210 by tilting, sliding, or moving the insect rearing tray 202 using any other suitable motion. In other examples, non-mechanical means, such as thermal, pneumatic, or chemical means, are used in the insect rearing tray 202 to help evenly distribute the food products 200 and the mixture 210. For example, an air stone may be introduced into the liquid 204 which diffuses air to create bubbles and ripples in the liquid 204.

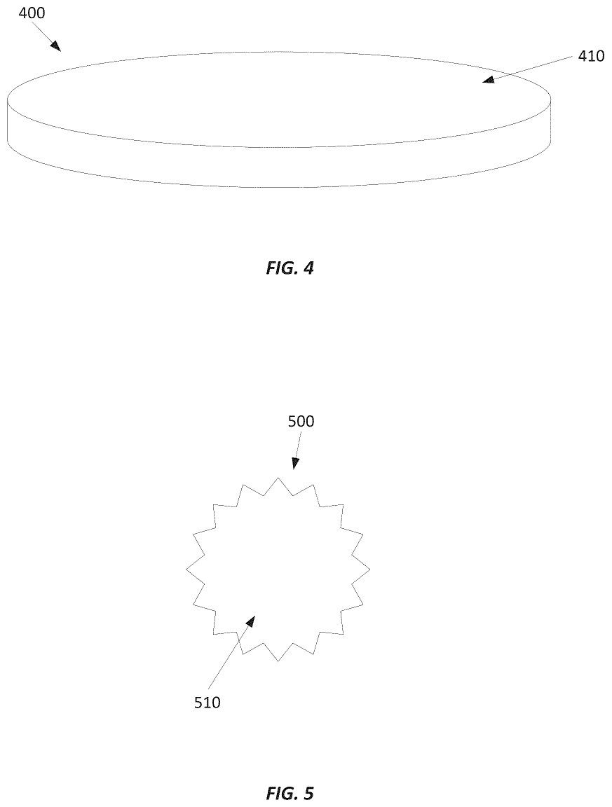

Referring now to FIGS. 3A and 3B, FIGS. 3A and 3B show another example of a reformatted insect food product 300 for aquatic environments. In this example, a measured amount of a mixture 310 of powdered food, as discussed above in reference to the mixture 110 in FIGS. 1A and 1B, is formed into a pellet by pressing the mixture into a molded shape. The pellet is a small, rounded, compressed mass of the mixture 310 that forms the reformatted insect food product 300. While the food product 300 is described and shown as forming a spherical shape, the food product 300 may be compressed to form any suitable shape for dispensing the measured amount of the mixture 310 into the aquatic environment. Specific examples of other shapes are discussed in more detail below in reference to FIGS. 4 and 5.

In some examples, the mixture 310 of powdered food may also include any suitable dissolvable binding substance 308, as discussed above in reference to FIGS. 1A and 1B, that may be used to assist in forming and maintaining the food mixture 310 in the molded pellet shape. The dissolvable binding substance 308 may be integrally mixed with the mixture 310 of powdered food or it may coat the outer surface of the molded pellet, as is shown in FIG. 3B.

In this example, the dissolvable binding substance 308 is biologically inert. However, in some examples, the dissolvable binding substance 308 may be designed to provide additional nutrients to the insect larvae or pupae in the aquatic environment, as described above in reference to FIGS. 1A and 1B. In some examples, the dissolvable binding substance 308 may be designed to dissolve at predetermined rates, as was discussed above in reference to the dissolvable capsule 108 in FIGS. 1A and 1B. Adjusting the rate at which the dissolvable binding substance 308 dissolves may provide certain advantages as discussed above in FIGS. 1A and 1B.

Additionally, the shape of the reformatted insect food product 300 itself may be designed to control the rate at which the mixture 310 dissolves. For example, a food product 300 that has a large ratio of surface area per volume will dissolve faster than a food product 300 that has a small ratio of surface area per volume.

Referring now to FIG. 4, FIG. 4 shows another example of a reformatted insect food product 400 for aquatic environments. In this example, the reformatted insect food product 400 is formed in the same way and using the same materials as discussed above in reference to FIGS. 3A and 3B. Here, the food product 400 is formed into a tablet by pressing the mixture 410 into a small disk or cylinder molded shape.

Referring now to FIG. 5, FIG. 5 shows another example of a reformatted insect food product 500 for aquatic environments. In this example, the reformatted insect food product 500 is formed in the same way and using the same materials as discussed above in reference to FIGS. 3A and 3B. Here, the food product 500 is formed into a granule. The granule is a small, compressed, irregularly-shaped mass of the mixture 510.

Referring now to FIG. 6, FIG. 6 shows another example of a reformatted insect food product 600 for aquatic environments. In this example, the mixture 610 of powdered food, as discussed above in reference to FIGS. 1A and 1B, is integrally mixed with any suitable dissolvable binding substance. The mixture 610 of the powdered food and the dissolvable binding substance is then extruded, pressed, or rolled into a food sheet. However, any other suitable method may be used for forming the food sheet. In some examples, the food sheet may be divided into smaller sections to feed to the insect larvae or pupae. In other examples, the food sheet may be coated with more of the dissolvable binding substance to prevent the food sheet from dissolving or losing its shape before being deposited into an aquatic environment to feed the insect larvae or pupae. When the coated food sheet is deposited into the aquatic environment to feed the insect larvae or pupae, the coating will dissolve as discussed above in reference to FIGS. 3A and 3B.

Referring now to FIG. 7, FIG. 7 shows another example of a reformatted insect food product 700 for aquatic environments. In this example, the reformatted insect food product 700 is formed in the same way and using the same materials as discussed above in reference to FIG. 6. Here, the mixture 710 and the dissolvable binding substance are extruded, pressed, or rolled into a food rope to form the food product 700, which may be further segmented into individual pieces to be deposited into an aquatic environment, such as by using the device shown in FIG. 2. Additionally, any other suitable method may be used for forming the food rope.

Referring now to FIG. 8, FIG. 8 shows an example carrier 802 for storing a reformatted insect food product 800 for aquatic environments. In this example, the carrier 802 is a sponge. The measured amount of the mixture 810 of powdered food, as discussed above in reference to FIGS. 1A and 1B, may be stored in the sponge until ready to be fed to the insect larvae or pupae. For example, the mixture 810 may be mixed with water to form a slurry. After which time, the sponge may be dipped into the slurry mixture to absorb the mixture 810 and to coat the sponge with it. The sponge and the slurry may then be allowed to dry. Once dried, the sponge may be later retrieved and placed into an aquatic environment with insect larvae or pupae. The liquid wets the slurry mixture allowing it to disperse from the sponge into the environment over time to feed the insect larvae or pupae.

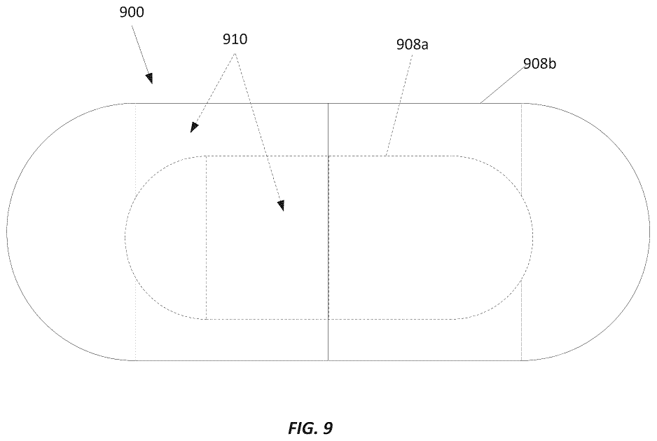

Referring now to FIG. 9, FIG. 9 shows another example of a reformatted insect food product 900 for aquatic environments. In this example, the food product 900 is a nested series of pills, where the pills are those described in reference to FIGS. 1A and 1B. At least two dissolvable capsules 908 may be provided to form the food product 900. A first measured amount of the mixture 910, as described in reference to FIGS. 1A and 1B, is placed into a first dissolvable capsule 908a, and then the first dissolvable capsule 908a is sealed. A second measured amount of the mixture 910 and the now sealed first dissolvable capsule 908a are placed into a second dissolvable capsule 908b, and then the second dissolvable capsule 908b is sealed. Similar to pills with dissolvable capsules that dissolve a different rates, the nested series of pills results in the first and second measures amounts of the mixture 910 being released at different times. So the feeding of the insect larvae or pupae may be scheduled and controlled by dispersing the nested series of pills into the aquatic environment to feed the larvae or pupae. And while FIG. 9 depicts two capsules, one nested within the other, any additional capsules may be nested, e.g., three or four successively nested capsules may be employed in some examples. Such examples may enable extended periods where the food supply for an aquatic environment does not require additional food to be added.

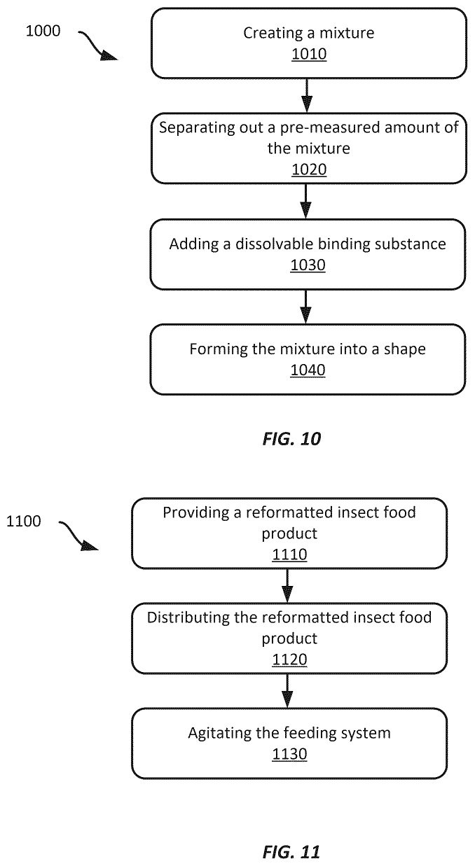

Referring now to FIG. 10, FIG. 10 shows an example method 1000 for manufacturing a reformatted insect food product according to this disclosure. The example method 1000 will be discussed with respect to the reformatted insect food product 100 described in reference to FIGS. 1A and 1B. However, it should be appreciated that any suitable reformatted insect food product for aquatic environments may be employed, such as those shown in FIGS. 3A-9.

At block 1010, a mixture 110 that includes cricket protein powder 102, as discussed above in relation to FIGS. 1A and 1B, is created. In some examples, the mixture 110 includes cricket protein powder 102 and bovine liver powder 104. The proportion of cricket protein powder 102 to bovine liver powder 104 may be varied such that the mixture 110 is made from at least 1% by weight cricket protein powder 102. For example, the reformatted insect food product 100 may be made from a mixture 110 of substantially 50% by weight cricket protein powder 102 and substantially 50% by weight bovine liver powder 104; however, in some examples, the only protein in the mixture 110 may be cricket protein powder 102.

At block 1020, the mixture 110 is separated out into a measured amount. For example, the measured amount of the mixture 110 may be 200 mg, 500 mg, 1 g, or any other suitable amount depending on the number of larvae or pupae that are to be fed. For example, the amount of mixture may be based on the expected number of insect larvae or pupae within an aquatic environment. A population of 500 mosquito larvae may need approximately 1 gram of protein powder over their entire adolescence, e.g., approximately 7 days. Other insect species may require a different amount. A feeding interval may vary greatly depending on the population of larvae in the insect rearing tray 202. For example, the larvae should be fed often enough that the larvae do not starve between feedings, yet not so often that uneaten food accumulates in the aquatic environment.

By forming food products 100 from measured amounts of the mixture 110 of food powder, the food products 100 may dose consistent, accurate, and known amounts of food for the insect larvae and pupae. This will save time because a person no longer has to manually measure each dose of food for each feeding. The measured amount of the mixture fed to the insect larvae or pupae is also easily quantifiable, which allows for easy logging and reporting of the feeding of the insect larvae or pupae. Using the food products 100 also enables the use of an automated feeding system, which can help to maintain a feeding interval schedule suitable for the larvae in the insect rearing tray 202.

At block 1030, a dissolvable binding substance is added to the mixture 110. Any suitable dissolvable binding substance as described above in reference to FIGS. 1A and 1B may be used. In some examples, the type of food product 100 to be formed is taken into consideration when deciding what type of, if any, dissolvable binding substance should be added to the mixture 110.

At block 1040, the mixture 110 is formed into a dispensable food unit, such as the reformatted insect food product 100. In some examples, the food product 100 may be formed by adding the measured amount of the mixture 110 to a dissolvable capsule 108, as described above in reference to FIGS. 1A and 1B. In other examples, the food product 100 may be formed by molding and compressing the measured amount of the mixture 110 into a shape, such as the pellet, tablet, or granule discussed above in reference to FIGS. 3A-5. The reformatted insect food product 100 may include the dissolvable binding substance to bind the mixture 110 together and to help the food product 100 maintain its shape until the food product 100 is dispensed into the aquatic environment for the insect larvae or pupae to feed on.

In some examples, the food product 100 may be formed by molding the measured amount of the mixture 110, without a binding substance, into a shape and coating the shape with the dissolvable binding substance. Additionally, the dissolvable binding substance may be both added to the measured amount of the mixture 110 as well as coated onto the outer surface of the molded food product 100. In other examples, the measured amount of mixture 110 with the suitable dissolvable binding substance mixed in may be extruded, pressed, or rolled to form a food sheet or a food rope as discussed above in reference to FIGS. 6 and 7.

Referring now to FIG. 11, FIG. 11 shows an example method 1100 for feeding a plurality of insect larvae or pupae a reformatted insect food product according to this disclosure. The example method 1100 will be discussed with respect to the reformatted insect food product 100 described in reference to FIGS. 1A and 1B. However, it should be appreciated that any suitable reformatted insect food product for aquatic environments may be employed, such as those shown in FIGS. 3A-9.

At block 1110, the reformatted insect food product 100 is provided, where the reformatted insect food product 100 is described in detail above in reference to FIGS. 1A and 1B.

At block 1120, the reformatted insect food product 100 is distributed to the plurality of insect larvae or pupae in an aquatic environment 201, where the aquatic environment 201 is described in reference to FIG. 2. The food product 100 may be distributed manually, using an automated feeder as described above in reference to FIG. 2, or by any other suitable form of distribution. When the reformatted food product 100 is distributed, the mixture disperses into a cloud in the liquid 204 of the aquatic environment 201.

At block 1130, the aquatic environment is agitated to disperse the reformatted insect food product 100 throughout the liquid 204 in the insect rearing tray 202. The agitation may be achieved by adding a stirring device 212 or a vibration generator 214 to the tray 202, as described above in reference to FIG. 2. Agitating the liquid 204 of the aquatic environment to help disperse the reformatted insect food product 100 throughout the liquid 204 helps to ensure that all of the insect larvae or pupae present in the environment are receiving enough food.

Referring now to FIG. 12, FIG. 12 shows an example computing device 1200 suitable for use in example methods for feeding a plurality of insect larvae or pupae a reformatted insect food product or manufacturing a reformatted insect food product. The example computing device 1200 includes a processor 1210 which is in communication with the memory 1220 and other components of the computing device 1200 using one or more communications buses 1202. The processor 1210 executes processor-executable instructions stored in the memory 1220 to assist with feeding a plurality of insect larvae or pupae a reformatted insect food product or manufacturing a reformatted insect food product, such as instructions for part or all of the example method 1000 described above with respect to FIG. 10 or example method 1100 described above with respect to FIG. 11. The computing device 1200, in this example, also includes one or more user input devices 1250, such as a keyboard, mouse, touchscreen, microphone, etc., to accept user input. The computing device 1200 also includes a display 1240 communicatively coupled to the processor 1210 using the one or more communications buses 1202 to provide visual output to a user.

The computing device 1200 also includes a communications interface 1230. In some examples, the communications interface 1230 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and devices herein are described in terms of software executing on various machines, the methods and devices may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor includes a computer-readable medium, such as a random access memory (RAM) coupled to the processor. The processor executes computer-executable program instructions stored in memory, such as executing one or more computer programs. Such processors may include a microprocessor, a digital signal processor (DSP), an application-specific integrated circuit (ASIC), field programmable gate arrays (FPGAs), and state machines. Such processors may further include programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may include, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may include code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A reformatted insect food product, comprising:
a mixture comprising at least one nutrient source suitable for an aquatic organism;
a first dissolvable capsule casing containing a first measured amount of the at least one nutrient source within and being sealed to form a first sealed dissolvable capsule; and
a second dissolvable capsule casing containing a second measured amount of the at least one nutrient source and the first sealed dissolvable capsule, and wherein the second dissolvable capsule is sealed to form a second sealed dissolvable capsule.

2. The reformatted insect food product of claim 1, wherein the aquatic organism comprises insect larvae or pupae.

3. The reformatted insect food product of claim 1, wherein the aquatic organism comprises mosquito larvae or pupae.

4. The reformatted insect food product of claim 1, wherein the at least one nutrient source comprises bovine liver powder and cricket protein powder.

5. The reformatted insect food product of claim 1, wherein at least 50% by weight of the mixture is cricket protein powder.

6. The reformatted insect food product of claim 1, wherein a first substantially 50% by weight of the mixture is bovine liver powder, and a second substantially 50% by weight of the mixture is cricket protein powder.

7. The reformatted insect food product of claim 1, wherein the first dissolvable capsule casing is configured to dissolve at a first predetermined rate in an aquatic environment.

8. The reformatted insect food product of claim 7, wherein the second dissolvable capsule casing is configured to dissolve at a second predetermined rate in an aquatic environment.

9. The reformatted insect food product of claim 1, wherein the reformatted insect food product further comprises a third dissolvable capsule casing, wherein the third dissolvable capsule casing comprises a third measured amount of the at least one nutrient source within and is sealed to form a third sealed dissolvable capsule, and wherein the third sealed dissolvable capsule is disposed within the first sealed dissolvable capsule.

10. The reformatted insect food product of claim 1, wherein the reformatted insect food product is configured to dissolve in a liquid of an aquatic environment held in an insect-rearing tray and to release the mixture to feed the aquatic organism held in the insect-rearing tray.

11. The reformatted insect food product of claim 1, wherein the mixture further comprises a dissolvable binding substance formulated to dissolve at a predetermined rate.

12. The reformatted insect food product of claim 11, wherein the dissolvable binding substance comprises at least one of a starch, a sugar, an agar, a gelatin, or a pectin.

13. The reformatted insect food product of claim 11, wherein the dissolvable binding substance is biologically inert.

14. The reformatted insect food product of claim 11, wherein the dissolvable binding substance coats an outer surface of the mixture.

15. The reformatted insect food product of claim 1, wherein the reformatted insect food product is configured to release the mixture to the aquatic organism in an aquatic environment held in an insect-rearing tray.

16. The reformatted insect food product of claim 1, wherein the reformatted insect food product is devoid of the aquatic organism.

17. The reformatted insect food product of claim 1, wherein the reformatted insect food product is formed into a dispensable unit.

18. A reformatted insect food product, comprising:
at least one nutrient source suitable for an aquatic organism;
a first dissolvable capsule casing containing a first measured amount of the at least one nutrient source within and being sealed to form a first sealed dissolvable capsule; and
a second dissolvable capsule casing containing a second measured amount of the at least one nutrient source and the first sealed dissolvable capsule, and wherein the second dissolvable capsule is sealed to form a second sealed dissolvable capsule.

19. The reformatted insect food product of claim 18, wherein the first sealed dissolvable capsule is characterized by a first volume, wherein the first measured amount of the at least one nutrient source occupies substantially all of the first volume, wherein the second sealed dissolvable capsule is characterized by a second volume, and wherein the first sealed dissolvable capsule and the second measured amount of the at least one nutrient source occupy substantially all of the second volume.

20. The reformatted insect food product of claim 18, wherein the first dissolvable capsule casing comprises a first set of two halves that together define the first dissolvable capsule, and wherein the second dissolvable capsule casing comprises a second set of two halves that together define the second dissolvable capsule.
